(19) United States
(12) Patent Application Publication
(10) Pub. No.: US 2025/0306298 A1
(43) Pub. Date: Oct. 2, 2025

(54) PLURALITY OF OPTICAL WAVEGUIDE LAYERS OPTICALLY COUPLED USING DIRECT OPTICAL WIRING

(71) Applicant: Intel Corporation, Santa Clara, CA (US)

(72) Inventors: Junyi QIU, Portland, OR (US); Mozhgan MANSURI, Portland, OR (US); Beom-Taek LEE, Beaverton, OR (US); Duanni HUANG, San Jose, CA (US)

(21) Appl. No.: 18/620,687

(22) Filed: Mar. 28, 2024

(51) Int. Cl. G02B 6/42

(52) U.S. Cl. CPC G02B 6/4206; G02B 6/423

(57) ABSTRACT

Embodiments disclosed herein comprise an apparatus with a first substrate, and a first row of fibers over the first substrate. In an embodiment, a second row of fibers is over the first substrate and above the first row of fibers, where one or more fibers in the first row of fibers and the second row of fibers comprise a diameter. In an embodiment, a combined height of the first row of fibers and the second row of fibers is no greater than double the diameter. In an embodiment, the apparatus further comprises a second substrate over the second row of fibers.

### BACKGROUND

Optical data links are potential candidates to address scalability challenges of electrical interconnects over long distances due to their potential for negligible frequency-dependent loss. Optical interconnects based on integrated photonics (e.g., silicon photonics) or discrete photonics (e.g., vertical cavity surface-emitting lasers (VCSELs), micro light emitting diodes (μLEDs), a photodiode (PD), etc.) are used in various applications. The optical signals from these devices are transmitted to optoelectronic dies through optical fibers or other interconnects. Often, optical fibers are coupled to the die through a fiber array unit (FAU). However, the FAU is often shoreline limited. That is, the number of data transmission lanes is limited by the length of the edge of the FAU. Additionally, tight alignment tolerances require larger pitches between fibers in the FAU, which further limits the number of data transmission lanes. Accordingly, the per-area bandwidth density is sub-optimal for existing solutions. This gives rise to a conflict between design goals targeted at increasing bandwidth and decreasing optical package form factor.

### BRIEF DESCRIPTION OF THE DRAWINGS

FIG. 1A is a cross-sectional illustration of a mechanical optical interface that is used to optically couple an optical component to a fiber array unit (FAU).

FIG. 1B is a cross-sectional illustration of an edge coupling approach for optically coupling an optical component to an FAU.

FIG. 1C is a cross-sectional illustration of a three-dimensional (3D) printed optical interconnect for optically coupling an optical component to an FAU.

FIGS. 2A-2C are cross-sectional illustrations depicting a 3D printing process that can be used to generate optical interconnects for optically coupling components together, in accordance with an embodiment.

FIG. 3A is a cross-sectional illustration of an optical package that comprises optical components in a plurality of rows that are each optically coupled to an FAU with multiple rows of fibers by optical interconnects, in accordance with an embodiment.

FIG. 3B is a perspective view illustration of an optical package with optical components in a plurality of rows and columns that are each optically coupled to an FAU with multiple rows of fibers by optical interconnects, in accordance with an embodiment.

FIG. 3C is a cross-sectional illustration of an optical package that comprises optical components in a plurality of rows that are each optically coupled to an FAU with multiple rows of fibers by optical interconnects, in accordance with an additional embodiment.

FIG. 4A is a perspective view illustration of an FAU with a plurality of rows of fibers in a vertical stack, in accordance with an embodiment.

FIG. 4B is a perspective view illustration of an FAU with a plurality of rows of fibers in a lateral stack, in accordance with an embodiment.

FIG. 5 is a perspective view illustration of a pair of optical components that are optically coupled to each other by multiple rows of stacked optical interconnects, in accordance with an embodiment.

FIG. 6A is a cross-sectional illustration of an FAU with a first row of fibers in V-grooves and an overlying second row of fibers, in accordance with an embodiment.

FIG. 6B is a cross-sectional illustration of an FAU with a first row of fibers and a second row of fibers directly on the first row of fibers, in accordance with an embodiment.

FIG. 6C is a cross-sectional illustration of a fiber bundle with a first fiber ribbon directly on a second fiber ribbon, in accordance with an embodiment.

FIG. 7A is a cross-sectional illustration of a stacking arrangement of a plurality of fiber ribbons, in accordance with an embodiment.

FIG. 7B is a cross-sectional illustration of a stacking arrangement of a plurality of fiber ribbons, in accordance with an additional embodiment.

FIG. 7C is a perspective view illustration of an optical cable with a plurality of fiber ribbons in a bundle, in accordance with an embodiment.

FIG. 7D is a perspective view illustration of an optical cable that is optically coupled to a plurality of optical components with optical interconnects, in accordance with an embodiment.

FIG. 8 is a cross-sectional illustration of an electronic system with optical components on a package substrate that are optically coupled to a multi-layer FAU by optical fibers, in accordance with an embodiment.

FIG. 9 is a schematic of a computing device built in accordance with an embodiment.

### DETAILED DESCRIPTION

Described herein are electronic systems, and more particularly, fiber array units with multilayer architectures to increase bandwidth, in accordance with various embodiments. In the following description, various aspects of the illustrative implementations will be described using terms commonly employed by those skilled in the art to convey the substance of their work to others skilled in the art. However, it will be apparent to those skilled in the art that the present disclosure may be practiced with only some of the described aspects. For purposes of explanation, specific numbers, materials and configurations are set forth in order to provide a thorough understanding of the illustrative implementations. However, it will be apparent to one skilled in the art that the present disclosure may be practiced without the specific details. In other instances, well-known features are omitted or simplified in order not to obscure the illustrative implementations.

Various operations will be described as multiple discrete operations, in turn, in a manner that is most helpful in understanding the present disclosure, however, the order of description should not be construed to imply that these operations are necessarily order dependent. In particular, these operations need not be performed in the order of presentation.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

As noted above, optical data links are a promising technology to scale data transmission rates. However, the efforts and structures necessary to enable optical coupling between components is significant. For example, great care needs to be taken in order to provide precise alignment in order to enable high data transmission rates. Typically, this is done through the use of V-grooves and precise placement of optical components on a board or package substrate. Mechanical coupling structures used for this alignment are often bulky as well. Accordingly, adding more coupling structures can significantly increase the form factor of the optical package.

The need for precise alignment for optical coupling to the fiber array unit (FAU) typically limits the FAU to a single row of optical fibers. This leads to the problem of the system being “shoreline limited”. That is, with existing fiber termination solutions the number of lanes (i.e., fibers) is limited to the number that can fit along an edge of the FAU. This limitation is further constrained by the fiber diameter. As such, shoreline density can only be scaled to a certain extent. Stated differently, the per-area bandwidth density is not able to be scaled further through the use of existing architectures.

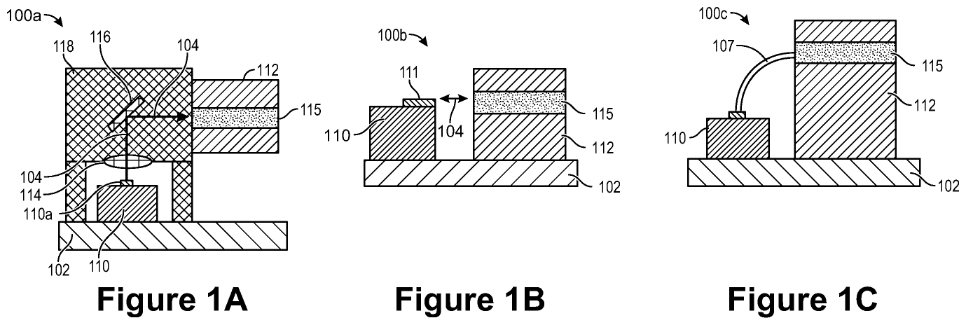

Referring now to FIGS. 1A-1C, a series of cross-sectional illustrations depicting a set of three different optical coupling solutions that suffer from shoreline limited architectures is shown.

Referring now to FIG. 1A a cross-sectional illustration of an optical package 100a with a vertical optical coupling architecture is shown. As shown, an optical component 110 and an FAU 112 are provided on a package substrate 102. The optical component 110 may be any suitable optical component with a vertical emission of light 104, such as a vertical cavity surface-emitting laser (VCSEL) device, a micro light emitting diode (μLEDs) device, a photodiode (PD) device, etc. In the illustration of optical package 100a, an aperture 110a emits light 104 in a vertical direction (i.e., away from a top surface of the optical component 110). The light 104 may pass into a mechanical optical interface (MOI) 118 that redirects the light 104 in a horizontal direction (i.e., parallel to the top surface of the optical component 110) towards a fiber 115 in the FAU 112. For example, the light 104 may pass through a collimator 114 before reflecting off of a reflector 116. In order to provide the necessary alignment, the fiber 115 may be set in a V-groove (not shown) in the FAU 112. As can be appreciated, the MOI 118 is large and includes expensive optical elements (e.g., the collimator 114 and the reflector 116). This negatively impacts efforts to increase per-area bandwidth density, while also increasing the cost per data lane.

FIG. 1B is another example of an optical package 100b that uses edge coupling. Similar to optical package 100a, an optical component 110 and an FAU 112 are provided on a package substrate 102. However, the optical component 110 may emit light 104 from an edge of the optical component 110. For example, the optical component 110 may be an integrated photonics device (e.g., a silicon photonics device, a group III-V semiconductor photonics device or the like). As shown, the light 104 is emitted from region 111, which may be the semiconductor region of the optical component 110. The light 104 travels parallel to the top surface of the package substrate 102 to reach the fiber 115 in the FAU 112. The fiber 115 may be set in a V-groove (not shown) in order to provide improved alignment. Without significant increases in complexity, the use of such edge coupling solutions is limited to a single layer of fibers 115 in the FAU 112. As such, per-area bandwidth density is not able to scale.

FIG. 1C is another example of an optical package 100c that uses an optical interconnect (which may also be referred to as an optical waveguide) to couple an optical component 110 to an FAU 112. As shown, the optical component 110 may be a vertically oriented optical component (similar to the optical component 110 in FIG. 1A). As shown, an optical interconnect 107 provides both a vertical and lateral path for light (which is confined within the optical interconnect 107) in order to reach the fiber 115 in the FAU 112. However, as presently available, the optical interconnect 107 only works with a single row of fibers 115 in the FAU 112. As such, the per-area bandwidth density is not able to scale for this architecture either.

While some two-layer FAU solutions have been proposed, they are not without limitations. For example, each fiber layer of the FAU requires a dedicated V-groove substrate in order to provide the proper alignment between the optical coupling solution. This significantly increases the height of the FAU so that it is not practical for many optical packaging applications. For example, dual layer FAU solutions may have a height that is approximately 2.5 mm or greater.

Accordingly, embodiments disclosed herein include an optical interconnect solution that allows for improvements to per-area bandwidth density without sacrificing significant increases in height. Such optical interconnect solutions are enabled through the use of optical interconnects that are printed with a three-dimensional (3D) printing process. The 3D printing process provides greater tolerance for the alignment of fibers within the FAU. For example, the optical interconnect may be printed with a nozzle that moves between an aperture of the optical component and the fiber within the FAU. That is, the optical interconnect is capable of directing the light directly to the fiber within the FAU as opposed to relying on preset alignments. Therefore, the fibers within the FAU can be packed in multiple layers, with a tighter pitch, and with significantly improved (i.e., larger) alignment tolerances.

Since optical coupling efficiency is decoupled from the precise alignment of the fibers in the FAU (and/or placement of the optical component), the need for V-grooves for each layers of fibers is eliminated. This allows for significant height savings in the FAU when multiple fiber layers are used. For example, each additional layer of fibers may only add an amount to the thickness that is up to the diameter of the fiber.

Adding additional layers to the FAU provides the ability to accept more lanes along each edge of the device. However, arranging the optical components so that they can access these additional lanes is still an issue for traditional optical coupling solutions. However, with 3D printed optical interconnects, the optical components may be set in rows adjacent to the FAU. The optical interconnects from optical components spaced away from the FAU can be made by passing the optical interconnect above the optical interconnects that couple the closer optical components to the FAU. Accordingly, more lanes are provided and an increase in the number of optical components is provided to occupy those additional lanes. Therefore, embodiments disclosed herein can significantly increase the per-area bandwidth density of the optical package.

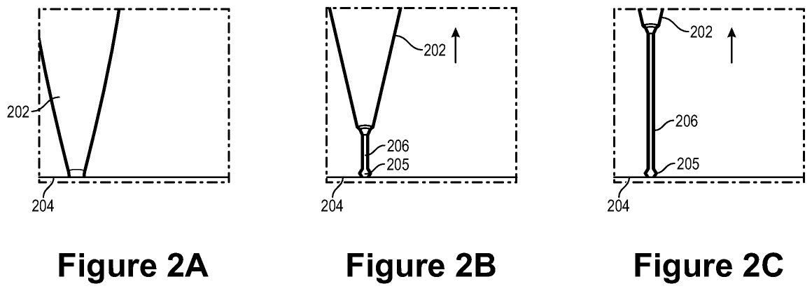

Referring now to FIGS. 2A-2C, a series of cross-sectional illustrations depicting a process for 3D printing optical interconnects is shown, in accordance with an embodiment. In an embodiment, the 3D printing process may include an extrusion process. Sometimes the 3D printing process for optical interconnects may be referred to as direct optical wiring (DOW).

Referring now to FIG. 2A, a cross-sectional illustration of the start of a 3D printing process for forming optical interconnects is shown, in accordance with an embodiment. As shown, a tip of a nozzle 202 is placed on a surface 204. The surface 204 may be an aperture of a first optical component (not shown) or another optical structure (e.g., fiber, silicon photonics, etc.). In an embodiment, the nozzle 202 may be controlled by automated processing. In some embodiments, an optical sensor (e.g., camera) may guide the nozzle 202 to the proper location on the surface 204 where an end of the optical interconnect is desired.

Referring now to FIG. 2B, a cross-sectional illustration of the nozzle 202 being retracted away from the surface 204 (as indicated by the arrow) is shown, in accordance with an embodiment. In an embodiment, the nozzle 202 may extrude a polymeric material through the tip of the nozzle 202 as the nozzle 202 is retracted. This forms a polymer wire 206 that will become an optical waveguide in free space between the surface 204 and the nozzle 202. In an embodiment, the polymer wire 206 may include a bump 205 on the surface 204. The bump 205 may have a width that is wider than a width (or diameter) of the polymer wire 206. Control of extrusion parameters, nozzle 202 speed, and/or the like may be used in order to control a width of the bump 205 relative to the width of the polymer wire 206. In some embodiments, the extrusion process may be optimized such that the bump 205 is substantially omitted.

Referring now to FIG. 2C, a cross-sectional illustration of the nozzle 202 during further retraction from the surface 204 is shown, in accordance with an embodiment. In an embodiment, the length of the polymer wire 206 may continue to be extended so long as the nozzle 202 continues moving and extruding polymer material. In the illustrated embodiment, the polymer wire 206 is shown in a vertical orientation relative to the surface 204. In other implementations, the polymer wire 206 may be created in a horizontal fashion, or the polymer wire 206 may be created as an arc or a semicircular pattern. After the polymer wire 206 has reached a desired length along a path, the nozzle 202 may contact a second optical component (or other optical structure) in order to terminate the polymer wire 206. The termination of the second end of the polymer wire 206 may also have a bump similar to bump 205. The nozzle 202 may be guided to the location of the termination point by a camera or the like. Since the nozzle 202 may be free to move in any direction, the positioning of the first optical component relative to the second optical component is not critical. This provides significant freedom to position optical structures in non-conventional ways in order to improve per-area bandwidth density, in accordance with embodiments disclosed herein.

In an embodiment, using polymer wires 206 for light coupling removes the need for a collimation and/or focusing mechanism that may be necessary when light crosses a device/air or fiber/air interface. Reflectors are also no longer necessary to steer light between optical components since the polymer wire 206 (which functions as an optical waveguide) can make bends, turns, or the like. While polymer wires are described in greater detail herein, it is to be appreciated that any polymer, plastic, or glass material suitable for 3D printing may be used as the optical wire for any of the embodiments disclosed herein.

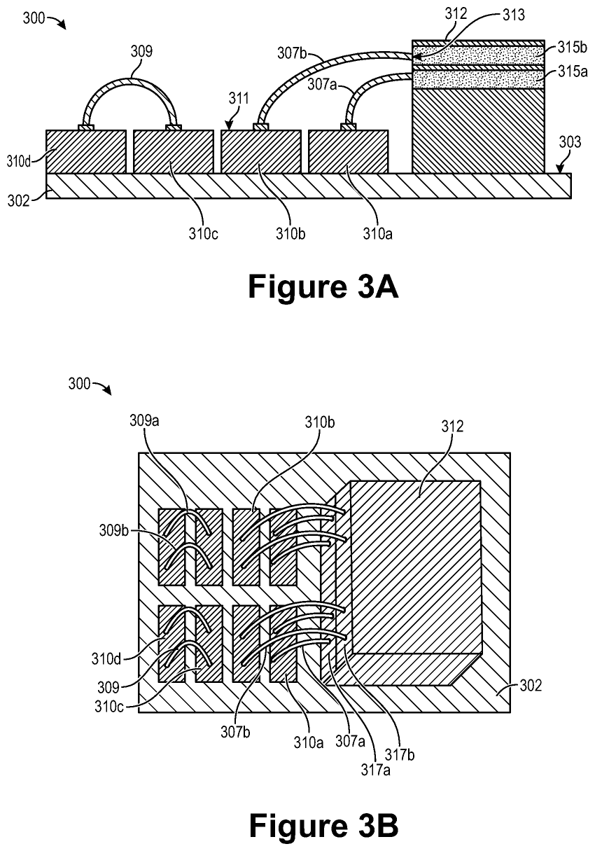

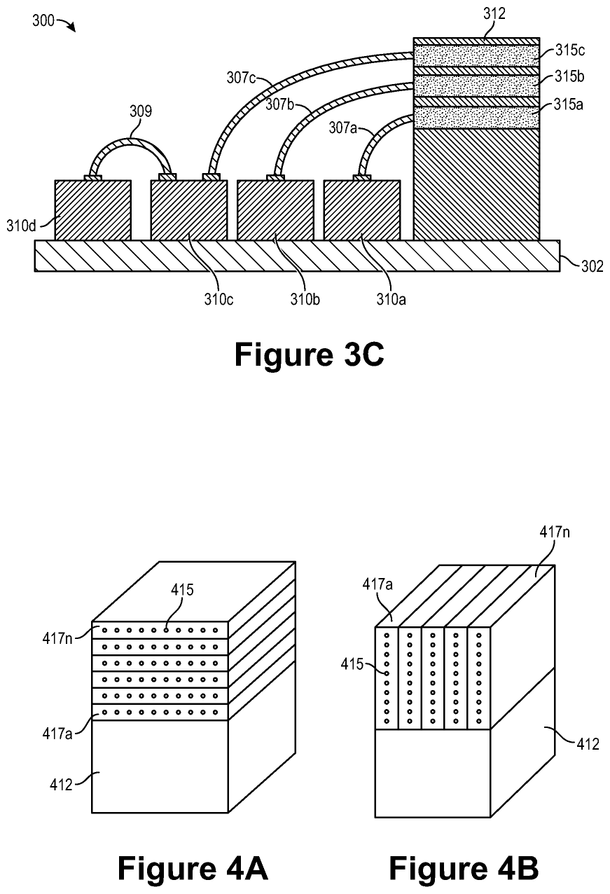

Referring now to FIGS. 3A-3C, a series of illustrations depicting optical packages that include optical coupling between optical components and an FAU are shown, in accordance with various embodiments. Particularly, the FAUs shown in FIGS. 3A-3C comprise multiple layers (i.e., rows) of optical fibers to increase the number of lanes accessible along a single edge of the system. In order to access the extra lanes, rows of optical components are provided adjacent to the FAU. The optical components are optically coupled to the FAU through the use of optical interconnects, such as polymer wire waveguides printed with a 3D printing process similar to printing processes described in greater detail herein.

Referring now to FIG. 3A, a cross-sectional illustration of an optical package 300 is shown, in accordance with an embodiment. In an embodiment, the optical package 300 may comprise a package substrate 302. The package substrate 302 may be an organic package substrate with (or without) a core (not shown). In an embodiment, the package substrate 302 may include electrical routing (e.g., copper pads, traces, vias, etc.). In other embodiments, the package substrate 302 may be replaced with a board (e.g., a printed circuit board (PCB) or the like) or any other substrate material.

In an embodiment, an FAU 312 is provided on a surface 303 of the package substrate 302. The FAU 312 may comprise a housing, such as a polymeric housing, a metallic housing, or the like. In an embodiment, a plurality of fibers 315 may be provided in the FAU 312. More particularly, a plurality of rows of fibers 315 may be provided in the FAU 312. For example, fiber 315a may be in a first row of fibers 315 and fiber 315b may be in a second row of fibers 315 above the first row of fibers 315a. In the cross-sectional plane shown in FIG. 3A, a single fiber 315a is shown in the first row of fibers 315 and a single fiber 315b is shown in the second row of fibers 315. However, as will be described in greater detail herein, a plurality of fibers 315a may be laterally adjacent to each other in the first row of fibers 315 and a plurality of fibers 315b may be laterally adjacent to each other in the second row of fibers 315. In some embodiments, one or both of the fibers 315a and 315b may be supported within a V-groove (not shown). Though, due to the flexibility enabled by embodiments disclosed herein, the exact positioning and alignment of the fibers 315a and 315b does not need to be highly controlled. As such, one or all V-grooves may be omitted in the FAU 312. Further, while two rows of fibers 315 are shown in FIG. 3A, it is to be appreciated that embodiments may comprise two or more rows of fibers 315.

In an embodiment, a plurality of optical components 310 may also be provided on the surface 303 of the package substrate 302. The optical components 310 may be provided adjacent to the FAU 312. For example, optical component 310a may be immediately adjacent to the FAU 312, optical component 310b may be immediately adjacent to the optical component 310a (on the other side from the FAU 312). Optical components 310c and 310d may also be on the surface 303 of the package substrate 302. In an embodiment, the optical components 310 may include any suitable optical device. In the illustrated embodiment, all of the optical components 310 are vertically oriented optical components 310, such as a VCSEL, a PD, a μLED, or the like. Though, embodiments may also include horizontally oriented optical components 310, such as a silicon photonics device.

In an embodiment, the optical component 310a may be optically coupled to the fiber 315a by a first optical interconnect 307a. The first optical interconnect 307a may be a polymer wire waveguide. For example, the polymer wire waveguide may be printed with a 3D printing process, such as the process described in greater detail above. In an embodiment, a first end of the first optical interconnect 307a is coupled to a top surface 311 of the optical component 310a, and the first end is oriented in a first direction relative to the surface 303 of the package substrate 302. In an embodiment, a second end of the first optical interconnect 307a is coupled to a face 313 of the fiber 315a of the FAU 312, and the second end is oriented in a second direction relative to the surface 303 of the package substrate 302. For example, the first direction may be substantially orthogonal to the surface 303 of the package substrate 302, and the second direction may be substantially parallel to the surface 303 of the package substrate 302.

Similarly, the optical component 310b may be optically coupled to the fiber 315b by a second optical interconnect 307b that is similar to the first optical interconnect 307a. In an embodiment, the first optical interconnect 307a and the second optical interconnect 307b may be provided in the same two-dimensional (2D) plane (e.g., the plane of FIG. 3A). As used herein, being within the same 2D plane (or simply within the same plane) may refer to two or more structures that are at least partially visible in any single cross-section. In some embodiments, the first optical interconnect 307a and the second optical interconnect 307b may be within the same plane through the entire length of both the first optical interconnect 307a and the second optical interconnect 307b. In other embodiments, the first optical interconnect 307a and the second optical interconnect 307b may be within the same plane for at least 25% of their lengths, for at least 50% of their lengths, for at least 75% of their lengths, or for at least 90% of their lengths.

As can be appreciated from FIG. 3A, the number of data lanes provided in the cross-section are doubled compared to existing solutions. Adding more rows of fibers 315 to the FAU 312 will further increase the number of data lanes. In order to fill those lanes in an economic and compact manner, 3D printed optical interconnects 307 provide the optical coupling to multiple rows of optical components 310.

Also shown in FIG. 3A is a pair of optical components 310c and 310d that are optically coupled together by a third optical interconnect 309. The third optical interconnect 309 may also be a 3D printed polymer wire waveguide, similar to optical interconnects 307a and 307b. The manufacturing flexibility of optical interconnect 309 allows for less demanding alignment between the optical component 310c and the optical component 310d.

Referring now to FIG. 3B, a partial perspective view illustration of an optical package 300 is shown, in accordance with an additional embodiment. In an embodiment, the optical package 300 may comprise a package substrate 302 that is similar to package substrate 302 shown in FIG. 3A. An FAU 312 is provided over the package substrate 302. As shown, the FAU 312 comprises a first row of fibers 317a and a second row of fibers 317b over the first row of fibers 317a. While the individual fibers 315 are omitted from FIG. 3B, it is to be appreciated that a plurality of fibers 315 may be arranged in a row within each row of fibers 317.

However, exemplary optical interconnects 307 are shown in FIG. 3B in order to illustrate the capability of optically coupling optical components 310 to each row of fibers 317 in the FAU 312 at multiple locations. For example, optical component 310a is optically coupled to the first row of fibers 317a by a pair of first optical interconnects 307a. Similarly, optical component 310b is optically coupled to the second row of fibers 317b by a pair of second optical interconnects 307b. While two optical coupling paths are shown for each optical component 310a and 310b, it is to be appreciated that two or more optical coupling paths may be provided by increasing the number of optical interconnects 307 on each optical component 310. In an embodiment, each pair of optical interconnects 307a and 307b may be within the same plane for at least part of their length. Further, it is to be appreciated that multiple optical components 310 may be optically coupled to a single row of fibers 317. For example, in FIG. 3B each row of fibers 317 is optically coupled to at least two optical components 310.

Also shown in FIG. 3B is a pair of optical components 310c and 310d that are optically coupled together by optical interconnects 309. In an embodiment, multiple optical interconnects 309 (e.g., optical interconnects 309a and 309b) may be provided between the single pair of optical components 310c and 310d.

Referring now to FIG. 3C, a cross-sectional illustration of an optical package 300 is shown, in accordance with an additional embodiment. In an embodiment, the optical package 300 in FIG. 3C may be similar to the optical package 300 in FIG. 3A, with the addition of an extra row of fibers 315 (e.g., fiber 315c) in the FAU 312. In order to occupy the additional lane, an optical interconnect 307c optically couples optical component 310c to the fiber 315c. Additionally, the optical component 310c may be optically coupled to an additional optical component 310d by an optical interconnect 309. Accordingly, optical component 310c is optically coupled to both an FAU 312 and an additional optical component 310d.

Referring now to FIGS. 4A and 4B, perspective view illustrations of FAUs 412 with alternative configurations are shown, in accordance with an embodiment. In FIG. 4A, the FAU 412 comprises vertically stacked rows of fibers 415, and in FIG. 4B, the FAU 412 comprises laterally stacked rows of fibers 415.

Referring now to FIG. 4A, a perspective illustration of an FAU 412 is shown, in accordance with an embodiment. As shown, the FAU 412 comprises a plurality of rows of fibers 417a-417n. For example, six rows of fibers 417 are shown in FIG. 4A. In an embodiment, each row of fibers 417 may comprise a set of fibers 415. For example, ten fibers 415 are provided along each row of fibers 417. Though, it is to be appreciated that any number of fibers 415 may be provided in each row of fibers 417. In an embodiment, the rows of fibers 417 may be stacked vertically over each other (e.g., one on top of another).

Referring now to FIG. 4B, a perspective illustration of an FAU 412 is shown, in accordance with an additional embodiment. As shown, the FAU 412 comprises a plurality of rows of fibers 417a-417n. For example, five rows of fibers 417 are shown in FIG. 4B. In an embodiment, each row of fibers 417 may comprise a set of fibers 415. For example, ten fibers 415 are provided along each row of fibers 417. Though, it is to be appreciated that any number of fibers 415 may be provided in each row of fibers 417. In an embodiment, the rows of fibers 417 may be stacked laterally with each other (e.g., with each row of fibers 417 laterally adjacent to the neighboring row of fibers 417).

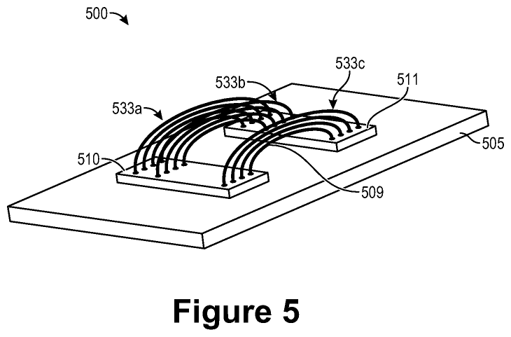

Referring now to FIG. 5, a perspective illustration depicting a pair of optical components that are optically coupled together by optical interconnects, such as polymer wire waveguides is shown, in accordance with an embodiment. The 3D printing process and structure of the optical interconnects allows for multiple optical coupling paths between the pairs of optical components with less demand on alignment. Embodiments also enable form factor reductions since additional coupling structures that occupy board space are not necessary.

Referring now to FIG. 5, a perspective view illustration of a portion of an optical package 500 is shown, in accordance with an embodiment. In an embodiment, the optical package 500 may comprise a board 505, such as a PCB. In an embodiment, a first optical component 510 and a second optical component 511 are provided on the board 505. In an embodiment, the first optical component 510 may be optically coupled to the second optical component 510 along two or more optical paths. For example, optical interconnects 509 optically couples the first optical component 510 to the second optical component 511. In and embodiment, the optical interconnects 509 are polymer wire waveguides similar to other optical interconnects described in greater detail herein.

The structure shown in FIG. 5 enables a higher optical coupling density (which enables a higher per-area bandwidth density between the optical components 510 and 511). This is because the two optical components 510 and 511 are no longer shoreline limited. That is, optical coupling can be made multiple rows back from an edge of both optical components 510 and 511.

In an embodiment, the optical interconnects 509 have a curvature or arc. In an embodiment, the plurality of optical interconnects 509 within a group 533 have different lengths (from a first end of the optical interconnect 509 to a second end of the optical interconnect 509. Additionally, the plurality of optical interconnects 509 within a group 533 may have curves with different apexes.

This arrangement allows for the optical interconnects 509 within a group 533 to be nested within the same plane. That is, the two or more optical interconnects 509 within a group 533 may be provided at least partially within the same plane in order to increase the density of optical interconnects between the first optical component 510 and the second optical component 511. While four optical interconnects 509 are shown in each group 533a-533c, it is to be appreciated that any number of optical interconnects 509 may be provided within the same plane by modifying the height of the apex of each additional optical interconnect 509.

As shown in FIG. 5, the first optical component 510 and the second optical component 511 are optically coupled at a plurality of locations. For example, a plurality of optical interconnect groups 533a-533c are shown. In an embodiment, each group 533 may comprise a plurality of nested optical interconnects 509. Accordingly, enhanced per-area bandwidth density is provided since a plurality of rows and columns of optical coupling locations can be provided for both optical components 510 and 511.

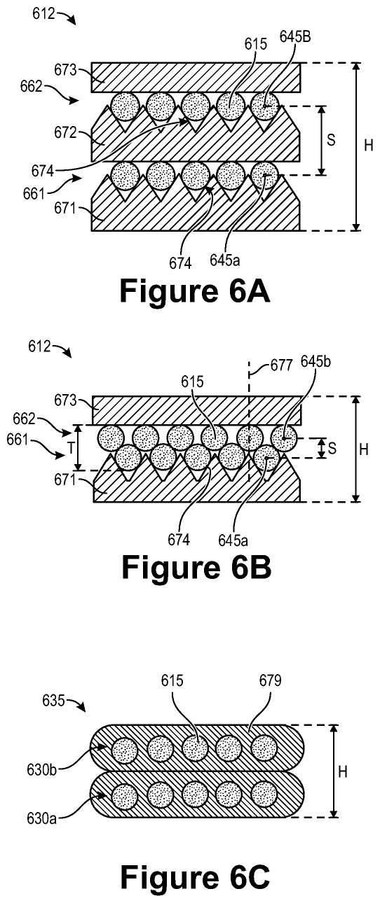

Referring now to FIGS. 6A-6C, a series of cross-sectional illustrations depicting FAUs (FIGS. 6A and 6B) and a fiber bundle structure (FIG. 6C) with enhanced fiber packing efficiencies is shown, in accordance with various embodiments. Particularly, the freedom provided by the 3D printing process used to form the optical interconnects allows for the alignment tolerance of the fibers to be loosened. As such, structures such as V-grooves may be omitted. Additionally, the pitch between fibers within a layer can be reduced, and the spacing between rows of fibers can be reduced as well. Reducing the spacing between rows allows for an overall reduction in the height of the FAU compared to traditional approaches.

Referring now to FIG. 6A, a cross-sectional illustration of a traditional approach to FAU 612 assembly is shown. As shown, the FAU 612 may comprise a first substrate 671. In order to align the first row of fibers 661, the first substrate 671 may comprise V-grooves 674, and each fiber 615 is set into one of the V-grooves 674. In order to add the second row of fibers 662, a second substrate 672 with more V-grooves 674 is needed. The fibers 615 of the second row of fibers 662 are then set into these additional V-grooves. A lid 673 (which may be referred to as a third substrate) may be placed over the second row of fibers 662 to prevent shifting of the fibers 615 in the FAU 612.

As shown, the center 645a of a fibers 615 in the first row of fibers 661 may be spaced apart in a vertical direction from the center 645b of fibers 615 in the second row of fibers 662 by a spacing S. The spacing S depends on a diameter of the fibers 615 as well as a thickness of the second substrate 672. Accordingly, a total height H of the FAU 612 is increased. For example, the total height H may be approximately 2.5 mm or greater. Further, the V-grooves increase the minimum pitch between the fibers 615. As such, the number of fibers 615 within a row of fibers 661 or 662 is limited.

Referring now to FIG. 6B, a cross-sectional illustration of an FAU 612 with greater freedom in fiber 615 placement is shown, in accordance with an embodiment. In an embodiment, the FAU 612 may comprise a first substrate 671 with V-grooves 674. In an embodiment, a first row of fibers 661 is provided over the first substrate 671. For example, fibers 615 in the first row of fibers 661 may each sit in a different one of the V-grooves. In an embodiment, the second row of fibers 662 may sit directly on the first row of fibers 661. That is, fibers 615 in the first row of fibers 661 may directly contact one or more fibers 615 in the second row of fibers 662. Though, in other embodiments, there may be a spacing between the first row of fibers 661 and the second row of fibers 662. In an embodiment, a combined height T of the first row of fibers 661 and the second row of fibers 662 is no greater than double the diameter of the fibers 615. Combined heights T less than twice the diameter of the fibers 615 is possible because the second row of fibers 662 may be laterally offset from the first row of fibers 661. For example, one or more fibers 615 in the second row of fibers 662 are positioned at midpoints 677 between different pairs of adjacent fibers 615 in the first row of fibers 661. In an embodiment, a top surface of a fiber 615 in the first row of fibers 661 may be above (in the Z-direction) a bottom surface of a fiber 615 in the second row of fibers 662. Alternatively, a vertical spacing S between a center 645a of a fiber 615 in the first row of fibers 661 and a center 645b of a fiber 615 in the second row of fibers 662 is less than a diameter of the fibers 615. In the illustrated embodiment, the pitch between fibers 615 within a row of optical fibers 661 or 662 are substantially uniform. However, in other embodiments a pitch between fibers 615 in the first row of fibers 661 and/or the second row of fibers 662 is non-uniform

In the illustrated embodiment, two rows of fibers 661 and 662 are shown as one example. However, other embodiments may include a plurality of stacked rows of fibers 661 and 662. For example, a third row of fibers (not shown) may be provided between the second row of fibers 662 and the lid 673 (which may be referred to as a second substrate). In the case of a third row of fibers, individual ones of the fibers 615 in the third row of fibers are aligned with individual ones of the fibers 615 in the first row of fibers 661. That is, centerlines of fibers 615 in the first row of fibers 661 and the third row of fibers may be substantially coincident with each other. Though, embodiments may also include offset fibers 615 in the third row of fibers.

As can be appreciated, the removal of a substrate between the first row of fibers 661 and the second row of fibers 662 provides significant reductions in the total height H of the FAU 612. For example, the height H may be less than approximately 2.5 mm, or less than 2.0 mm. Further the addition of more rows of fibers will result in minimal increases in the total height H. For example, the total height H may increase by a distance up to the diameter of the fibers 615 for each additional row of fibers. Additionally, while V-grooves 674 are shown on the first substrate 671, embodiments can omit the V-grooves 674 so that the first substrate 671 has a flat top surface. This is possible since alignment tolerances are loosened when optical interconnects are used in accordance with embodiments disclosed herein. When the V-grooves 674 are omitted, the total height H can be decreased even further.

Referring now to FIG. 6C, a cross-sectional illustration of a portion of a fiber bundle 635 is shown, in accordance with an additional embodiment. Due to the flexibility provided by the 3D printing process for the optical interconnects, the optical interconnects may be made directly to fiber bundles 635. In an embodiment, the fiber bundle 635 may comprise a plurality of fiber ribbons 630. For example, a first fiber ribbon 630a and a second fiber ribbon 630b are shown in FIG. 6C. Each fiber ribbon 630 may comprise a plurality of fibers 615 that are arranged in a row and embedded in a buffer layer 679. Such an architecture may provide an even more compact total height H. For example, the total height H may be equal to the thickness of the buffer layer 679 (e.g., from bottom to top) times the number of fiber ribbons 630. In such an embodiment, the total height H may be approximately 2.0 mm or less, approximately 1.0 mm or less, or approximately 0.5 mm or less. For example, the thickness of each buffer layer 679 may be approximately 0.5 mm or less, or approximately 0.25 mm or less.

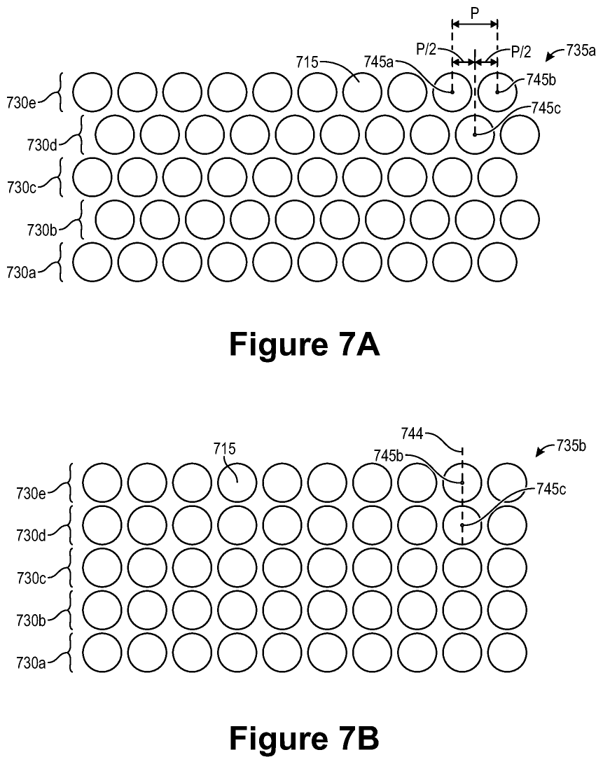

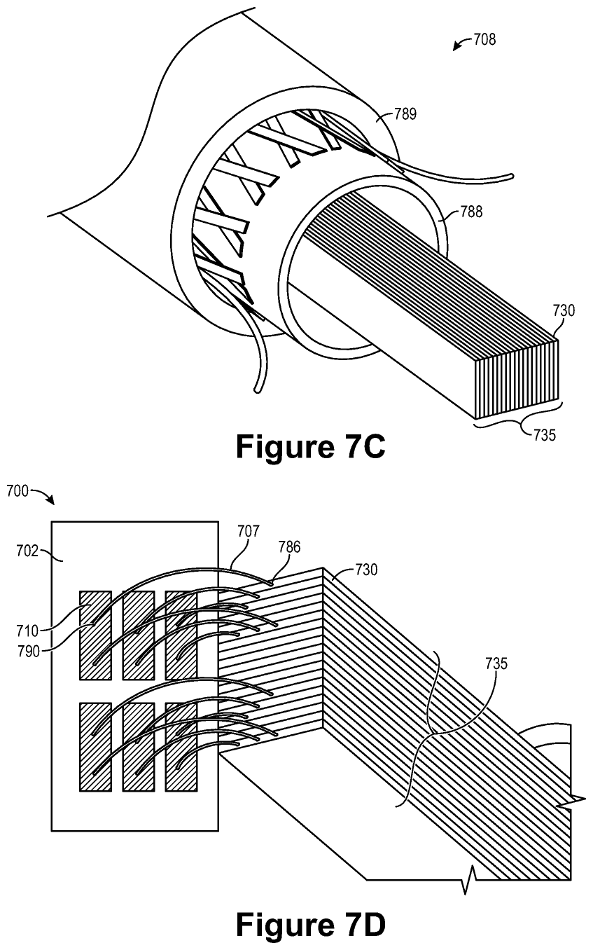

Referring now to FIGS. 7A-7D, a series of illustrations depicting the structure of fiber bundles (FIGS. 7A-7C) and the coupling of a fiber bundle to optical components (FIG. 7D) is shown, in accordance with an embodiment.

Referring now to FIG. 7A, a cross-sectional illustration of a fiber bundle 735a is shown, in accordance with an embodiment. In the illustrated embodiment, the buffer layer is omitted for simplicity. As shown, a plurality of ribbons 730a-730e are provided in the bundle 735. Though, the fiber bundle 735a may include any number of stacked ribbons 730. As shown, adjacent ribbons 730 are offset from each other. That is, center points 745 of fibers 715 may be offset between layers. For example, center points 745a and 745b of fibers 715 in ribbon 730e are offset from center point 745c of a fiber 715 in ribbon 730d. The distance between center points 745a and 745b may be the pitch P. In some embodiments, the lateral offset is equal to approximately half the pitch P. For example, a lateral distance between the center point 745a and the center point 745c may be approximately one-half the pitch P.

Referring now to FIG. 7B, a cross-sectional illustration of a fiber bundle 735b is shown, in accordance with an additional embodiment. In an embodiment, the fiber bundle 735b may be similar to the fiber bundle 735a with the exception of the ribbons 730 being aligned with each other. For example, center point 745c of fiber 715 in the ribbon 730d is aligned (along line 744) with center point 745b of fiber 715 in the ribbon 730e.

Referring now to FIG. 7C, a perspective view illustration of an optical cable 708 is shown, in accordance with an embodiment. In an embodiment, the optical cable 708 may comprise a fiber bundle 735 with a plurality of ribbons 730. The fiber bundle 735 and ribbons 730 may be similar to those described in greater detail herein. In an embodiment, the fiber bundle 735 may be surrounded by one or more cladding layers 788 and 789.

Referring now to FIG. 7D, a partial perspective view illustration of an optical package 700 is shown, in accordance with an embodiment. As shown, a plurality of optical components 710 may be provided on a package substrate 702. In an embodiment, a plurality of optical interconnects 707 may optically couple various optical components 710 to a fiber bundle 735. Particularly, the optical interconnects 707 may have a first end 790 at the optical component 710 and a second end 786 at a surface of a ribbon 730 within the fiber bundle 735. As shown, multiple optical interconnects 707 may be made to a single ribbon 730. As such, the number of data transmission lanes is greatly increased, and per-area bandwidth density can be significantly improved.

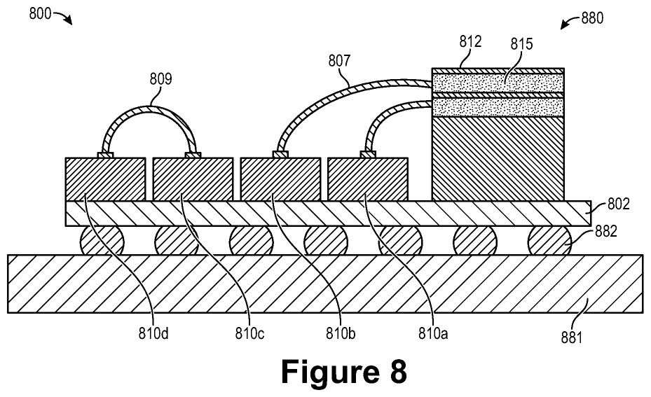

Referring now to FIG. 8, a cross-sectional illustration of an electronic system 880 is shown, in accordance with an embodiment. The electronic system 880 may comprise a board 881, such as a PCB, a motherboard, or the like. The board 881 may be coupled to a package substrate 802 through second level interconnects (SLIs) 882. The SLIs 882 may comprise solder joints, pins, sockets, or the like.

In an embodiment, the package substrate 802 may be part of an optical package 800. The optical package 800 may be similar to any of the optical packages 800 described in greater detail herein and may include elements similar to any of the elements described in greater detail herein. For example, an FAU 812 with a plurality of layers of optical fibers 815 may be provided on the package substrate 802. A plurality of optical components 810 may be optically coupled to the optical fibers 815 by optical interconnects 807. Optical interconnects 807 may be 3D printed polymer wire waveguides similar to any of the optical interconnects 807 described in greater detail herein. For example, optical components 810a and 810b are optically coupled to the FAU 812. In an embodiment, additional optical components 810c and 810d may be optically coupled to each other by an optical interconnect 809, which may be similar in structure and manufacture to optical interconnects 807. In an embodiment, the FAU 812 may be communicatively coupled to a die (not shown) that is configured to process data delivered along the optical interconnects 807. The die may be any type of die, such as a central processing unit (CPU), a graphics processing unit (GPU), an XPU, a communications die, a memory die, or the like.

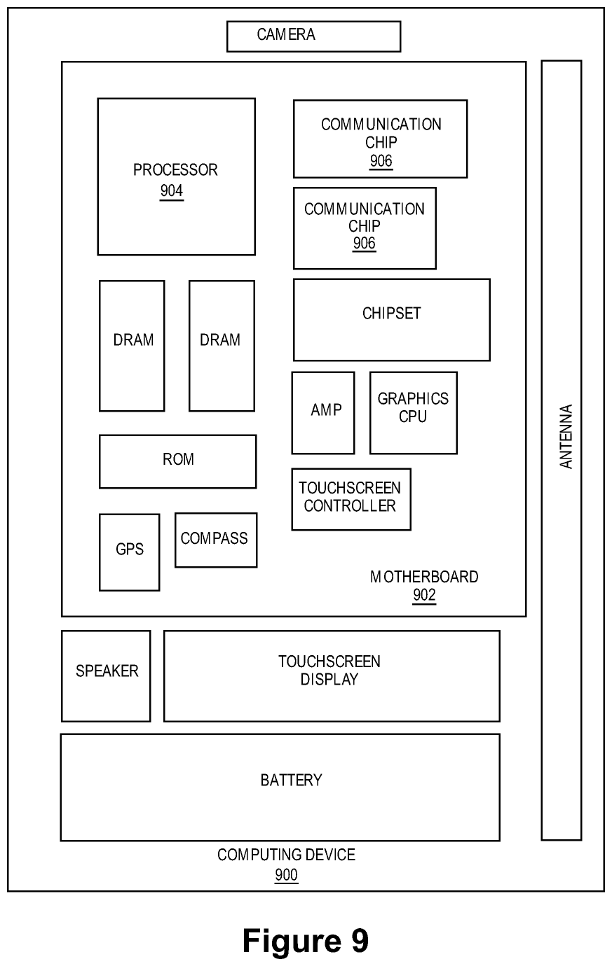

FIG. 9 illustrates a computing device 900 in accordance with one implementation of the disclosure. The computing device 900 houses a board 902. The board 902 may include a number of components, including but not limited to a processor 904 and at least one communication chip 906. The processor 904 is physically and electrically coupled to the board 902. In some implementations the at least one communication chip 906 is also physically and electrically coupled to the board 902. In further implementations, the communication chip 906 is part of the processor 904.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 906 enables wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 906 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 900 may include a plurality of communication chips 906. For instance, a first communication chip 906 may be dedicated to shorter range wireless communications such as Wi-Fi and Bluetooth and a second communication chip 906 may be dedicated to longer range wireless communications such as GPS, EDGE, GPRS, CDMA, WiMAX, LTE, Ev-DO, and others.

The processor 904 of the computing device 900 includes an integrated circuit die packaged within the processor 904. In some implementations of the disclosure, the integrated circuit die of the processor may be part of an optical package that comprises a multi-layer FAU with optical coupling to one or more optical components by 3D printed optical interconnects that are polymer wire waveguides, in accordance with embodiments described herein. The term “processor” may refer to any device or portion of a device that processes electronic data from registers and/or memory to transform that electronic data into other electronic data that may be stored in registers and/or memory.

The communication chip 906 also includes an integrated circuit die packaged within the communication chip 906. In accordance with another implementation of the disclosure, the integrated circuit die of the communication chip may be part of an optical package that comprises a multi-layer FAU with optical coupling to one or more optical components by 3D printed optical interconnects that are polymer wire waveguides, in accordance with embodiments described herein.

In an embodiment, the computing device 900 may be part of any apparatus. For example, the computing device may be part of a personal computer, a server, a mobile device, a tablet, an automobile, or the like. That is, the computing device 900 is not limited to being used for any particular type of system, and the computing device 900 may be included in any apparatus that may benefit from computing functionality.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

These modifications may be made to the disclosure in light of the above detailed description. The terms used in the following claims should not be construed to limit the disclosure to the specific implementations disclosed in the specification and the claims. Rather, the scope of the disclosure is to be determined entirely by the following claims, which are to be construed in accordance with established doctrines of claim interpretation.

Example 1: an apparatus comprising: a first substrate; a first row of fibers over the first substrate; a second row of fibers over the first substrate and above the first row of fibers, wherein one or more fibers in the first row of fibers and the second row of fibers comprise a diameter, and wherein a combined height of the first row of fibers and the second row of fibers is no greater than double the diameter; and a second substrate over the second row of fibers.

Example 2: the apparatus of Example 1, wherein a first fiber in the first row of fibers directly contacts a second fiber in the second row of fibers.

Example 3: the apparatus of Example 2, wherein a vertical spacing between a center of the first fiber and a center of the second fiber is less than the diameter.

Example 4: the apparatus of Examples 1-3, wherein a surface of the first substrate that faces the first row of fibers is flat.

Example 5: the apparatus of Examples 1-4, wherein a surface of the first substrate that faces the first row of fibers comprises a plurality of V-grooves, and wherein fibers in the first row of fibers are set into different ones of the plurality of V-grooves.

Example 6: the apparatus of Examples 1-5, wherein one or more fibers in the second row of fibers are positioned at midpoints between different pairs of adjacent fibers in the first row of fibers.

Example 7: the apparatus of Examples 1-6, wherein a pitch between fibers in the first row of fibers is non-uniform.

Example 8: the apparatus of Examples 1-7, further comprising: one or more additional rows of fibers between the second row of fibers and the second substrate.

Example 9: the apparatus of Example 8, wherein individual ones of the fibers in a third row of fibers if the additional rows of fibers are aligned with individual ones of the fibers in the first row of fibers.

Example 10: the apparatus of Examples 1-9, wherein a thickness of the apparatus is less than 2.5 mm.

Example 11: an apparatus, comprising: a substrate; a fiber array unit (FAU) on the substrate, wherein the FAU comprises: a first row of fibers; and a second row of fibers over the first row of fibers; a first optical component on the substrate and adjacent to the FAU, wherein the first optical component is optically coupled to a first fiber in the first row of fibers by a first optical interconnect; and a second optical component on the substrate and adjacent to the first optical component, wherein the second optical component is optically coupled to a second fiber in the second row of fibers by a second optical interconnect.

Example 12: the apparatus of Example 11, wherein the first optical interconnect and the second optical interconnect comprise a polymer material.

Example 13: the apparatus of Example 11 or Example 12, wherein the second fiber is vertically aligned with the first fiber within the FAU.

Example 14: the apparatus of Example 13, wherein the first optical interconnect and the second optical interconnect are positioned in substantially a same two-dimensional plane for at least 50% of lengths of both the first optical interconnect and the second optical interconnect.

Example 15: the apparatus of Examples 11-14, wherein a first end of the first optical interconnect is oriented in a first direction relative to a surface of the substrate and a second end of the first optical interconnect is oriented in a second direction relative to the surface of the substrate, and wherein the first direction is different than the second direction.

Example 16: the apparatus of Examples 11-15, wherein the substrate is a package substrate that is mounted to a board, or wherein the substrate is the board.

Example 17: the apparatus of Example 16, wherein the apparatus is part of a personal computer, a server, a mobile device, a tablet, or an automobile.

Example 18: an apparatus, comprising: a substrate; a first optical component on the substrate, wherein the first optical component comprises a plurality of first apertures; a second optical component on the substrate, wherein the second optical component comprises a plurality of second apertures; and a plurality of optical waveguides, wherein each of the plurality of optical waveguides optically couple one of the plurality of first apertures to one of the plurality of second apertures, and wherein the plurality of optical waveguides are positioned within a same two-dimensional plane.

Example 19: the apparatus of Example 18, wherein the plurality of optical waveguides comprise a polymer material.

Example 20: the apparatus of Example 18 or Example 19, wherein the plurality of optical waveguides each comprise a curve, and wherein each curve has an apex at a different distance from a surface of the substrate.

What is claimed is:

1. An apparatus comprising:
a first substrate;
a first row of fibers over the first substrate;
a second row of fibers over the first substrate and above the first row of fibers, wherein one or more fibers in the first row of fibers and the second row of fibers comprise a diameter, and wherein a combined height of the first row of fibers and the second row of fibers is no greater than double the diameter; and
a second substrate over the second row of fibers.

2. The apparatus of claim 1, wherein a first fiber in the first row of fibers directly contacts a second fiber in the second row of fibers.

3. The apparatus of claim 2, wherein a vertical spacing between a center of the first fiber and a center of the second fiber is less than the diameter.

4. The apparatus of claim 1, wherein a surface of the first substrate that faces the first row of fibers is flat.

5. The apparatus of claim 1, wherein a surface of the first substrate that faces the first row of fibers comprises a plurality of V-grooves, and wherein fibers in the first row of fibers are set into different ones of the plurality of V-grooves.

6. The apparatus of claim 1, wherein one or more fibers in the second row of fibers are positioned at midpoints between different pairs of adjacent fibers in the first row of fibers.

7. The apparatus of claim 1, wherein a pitch between fibers in the first row of fibers is non-uniform.

8. The apparatus of claim 1, further comprising:
one or more additional rows of fibers between the second row of fibers and the second substrate.

9. The apparatus of claim 8, wherein individual ones of the fibers in a third row of fibers if the additional rows of fibers are aligned with individual ones of the fibers in the first row of fibers.

10. The apparatus of claim 1, wherein a thickness of the apparatus is less than 2.5 mm.

11. An apparatus, comprising:
a substrate;
a fiber array unit (FAU) on the substrate, wherein the FAU comprises:
a first row of fibers; and
a second row of fibers over the first row of fibers;
a first optical component on the substrate and adjacent to the FAU, wherein the first optical component is optically coupled to a first fiber in the first row of fibers by a first optical interconnect; and
a second optical component on the substrate and adjacent to the first optical component, wherein the second optical component is optically coupled to a second fiber in the second row of fibers by a second optical interconnect.

12. The apparatus of claim 11, wherein the first optical interconnect and the second optical interconnect comprise a polymer material.

13. The apparatus of claim 11, wherein the second fiber is vertically aligned with the first fiber within the FAU.

14. The apparatus of claim 13, wherein the first optical interconnect and the second optical interconnect are positioned in substantially a same two-dimensional plane for at least 50% of lengths of both the first optical interconnect and the second optical interconnect.

15. The apparatus of claim 11, wherein a first end of the first optical interconnect is oriented in a first direction relative to a surface of the substrate and a second end of the first optical interconnect is oriented in a second direction relative to the surface of the substrate, and wherein the first direction is different than the second direction.

16. The apparatus of claim 11, wherein the substrate is a package substrate that is mounted to a board, or wherein the substrate is the board.

17. The apparatus of claim 16, wherein the apparatus is part of a personal computer, a server, a mobile device, a tablet, or an automobile.

18. An apparatus, comprising:
a substrate;
a first optical component on the substrate, wherein the first optical component comprises a plurality of first apertures;
a second optical component on the substrate, wherein the second optical component comprises a plurality of second apertures; and
a plurality of optical waveguides, wherein each of the plurality of optical waveguides optically couple one of the plurality of first apertures to one of the plurality of second apertures, and wherein the plurality of optical waveguides are positioned within a same two-dimensional plane.

19. The apparatus of claim 18, wherein the plurality of optical waveguides comprise a polymer material.

20. The apparatus of claim 18, wherein the plurality of optical waveguides each comprise a curve, and wherein each curve has an apex at a different distance from a surface of the substrate.
